(19) United States
(12) Patent Application Publication
(10) Pub. No.: US 2024/0360009 A1
(43) Pub. Date: Oct. 31, 2024

(54) DEVICE FOR HOLDING A FILTER PAD FOR WATER PURIFICATION

(71) Applicant: Waterdrop Microdrink GmbH, Wien (AT)

(72) Inventors: Philipp Liebentritt, Wien (AT); Viktor Tomm, Wien (AT); Thomas Gombas, Wien (AT); Christian Beckert, Wien (AT); Christoph Hermann, Wien (AT)

(73) Assignee: Waterdrop Microdrink GmbH, Wien (AT)

(21) Appl. No.: 18/769,576

(22) Filed: Jul. 11, 2024

Related U.S. Application Data
(63) Continuation of application No. PCT/EP2023/050518, filed on Jan. 11, 2023.

(30) Foreign Application Priority Data
Jan. 11, 2022 (DE) 202022100131.6
Nov. 30, 2022 (DE) 202022106713.9
Nov. 30, 2022 (DE) 202022106723.6

(51) Int. Cl. C02F 1/28; C02F 1/00

(52) U.S. Cl. CPC C02F 1/283; C02F 1/003; C02F 2201/003; C02F 2201/007

(57) ABSTRACT

The invention relates to: a device for holding a filter pad for water purification; an activated carbon filter for purifying drinking water; a table water filter; a filter system; a method for purifying water; and use of a device with a received filter pad. The device comprises: a frame having a connecting portion for detachably connecting with an inlet container, a holding element arranged within the frame, and forming a receiving region for receiving a filter pad, the receiving region having a height in the direction of the flow direction and a diameter in a radial direction orthogonal to the flow direction, a pressing region for fixing the filter pad, wherein the pressing region is formed by a first pressing element of the holding element and a second pressing element, wherein the first pressing element and the second pressing element are designed and arranged to compress a filter pad.

### CROSS REFERENCE TO RELATED APPLICATIONS

This application is a continuation of International Patent Application No. PCT/EP2023/050518, filed Jan. 11, 2023, which claims priority to German Patent Application No. 202022100131.6, filed Jan. 11, 2022, German Patent Application No. 202022106723.6, filed Nov. 30, 2022 and German Application No. 202022106713.9, filed Nov. 30, 2022. The contents of these applications are incorporated herein by reference in their entirety.

### FIELD

The invention relates to a device for holding a filter pad for water purification. Furthermore, the invention relates to an activated carbon filter for drinking water purification and a use of an activated carbon filter for drinking water purification. In addition, the invention relates to a table water filter and a filter system. Furthermore, the invention relates to a method for purifying water and a use of a device with a received filter pad.

Drinking water can be contaminated with impurities, undesirable substances or germs. It is therefore common practice to purify drinking water with filters. Various drinking water filters and drinking water filter systems are known.

Some drinking water filters use loose activated carbon granulate, for example, which is contained in a housing or filter cartridge. However, this form of drinking water filter has some disadvantages. For example, it is disadvantageous that the loose activated carbon granulate is contained in a plastic housing. As drinking water filters are only used for a certain number of cleaning cycles and are then replaced, waste that is difficult to recycle is produced in the form of the used filter cartridges, as the activated carbon granulate cannot be easily separated from the plastic housing. In addition, loose activated carbon granulate takes up a lot of space during use due to its low compression. It is also known from other filter systems that the filter holder cannot be easily separated from the filter used.

Another problem in the manufacture of filters for drinking water treatment is that design manufacturing variations occur during the production of filters or filter cartridges, which must be kept within manufacturing tolerances. The most important aspect in the design of filters for drinking water treatment is to ensure that no unfiltered water flows past the filter itself. The filter or filter holder must therefore be designed in such a way that complete separation of the purified and unpurified water is ensured despite design variations in the filter's manufacture. If a filter is inserted into a filter seat or a filter holder, a seal must therefore be achieved despite manufacturing fluctuations during the production of the filter.

The invention is therefore based on the task of providing an improved solution that addresses the aforementioned problems. In particular, it is the task of the invention to provide a solution with which simple water treatment is possible, whereby the components for water treatment should be as resource-saving as possible to produce and easy to recycle.

According to a first aspect, the problem is solved by a device according to claim 1. Accordingly, a device for holding a filter pad for water purification, in particular an activated carbon filter pad for water purification, is provided, the device comprising a frame having a connecting portion for making a detachable connection with an inlet container, a holding element arranged within the frame, wherein the holding element has an inlet opening and an outlet opening and a flow direction is formed from the inlet opening to the outlet direction, wherein the holding element forms a receiving region for receiving a filter pad, in particular a disk-shaped filter pad, wherein the receiving region has a height in the direction of the flow direction and a diameter in a radial direction which is orthogonal to the flow direction, a pressing region for fixing the filter pad, wherein the pressing region is arranged in the outer region of the receiving region in the radial direction, wherein the pressing region is formed by a first pressing element of the holding element and a second pressing element, wherein the first pressing element and the second pressing element are formed and arranged to compress a filter pad received in the receiving region in the radially outer region of the receiving region.

In particular, the device is designed to hold a filter pad for water purification. The device is thus preferably designed to hold a filter pad in the holding area. In particular, the holding element is designed to hold a filter pad. The device, together with the filter pad, is intended to purify water, in particular drinking water. Water purification can also be understood synonymously as water treatment. The filter pad can also be understood and referred to synonymously as a filter or filter element. Activated carbon is able to remove dissolved organic trace substances, such as pesticide substances or drug residues, from the water by adsorption.

The receiving region preferably has the same dimensions, i.e. in particular the same diameter and the same thickness, as the filter pad. In a specific embodiment, a receiving region with a diameter in a range from 20 mm to 150 mm is proposed, for example 70 mm. In addition, in a specific embodiment, the receiving region can have a height of 5 mm to 80 mm, for example 7.5 mm or 10.5 mm.

The frame together with the holding element arranged in the frame can be referred to as a filter holder. The frame is structurally rigid and preferably made of plastic. However, other structurally stable materials such as metal, painted wood, solid silicone, composite materials or the like can also be used for the frame. The frame serves as a supporting structure for the components of the filter holder. The frame can be of any shape, for example round or square. In a preferred embodiment, the frame is essentially ring-shaped. The frame can also be understood and referred to as a holding frame or housing. The connecting portion of the frame is designed in particular to establish a detachable connection with an inlet container. The connecting portion preferably has a fastening means with which a connection to an inlet container can be established.

The holding element forms the holding area for holding a filter pad. The holding area has a height in the flow direction and a diameter in a radial direction that is orthogonal to the flow direction.

The holding element is arranged inside the frame. The holding element has an inlet opening and an outlet opening, wherein a flow direction is formed from the inlet opening to the outlet direction. The flow direction describes a direction in which the water flows or seeps through the filter holder during predetermined operation and can also be understood as a direction of flow. The inlet opening is an opening or recess at which unfiltered water can enter the holding element. The outlet opening is in particular an opening, which can be formed from several recesses, at which filtered water can exit the holding element. The inlet opening and the outlet opening can also be understood as the inlet side or outlet side or as the inlet or outlet. It is understood that both the frame and the holding element each have an inlet opening and an outlet opening which, for example, are spatially in the same position or location, since the holding element is arranged in the frame.

The pressing section is designed in particular to fix the filter pad in the receiving region. The pressing section is arranged in the radially outer area of the receiving region. In particular, the pressing section is to be understood as a radially circumferential area of the receiving region, along which the filter pad is pressed together by means of opposing pressing elements. A first pressing element of the holding element is provided. A second pressing element is also provided. The second pressing element can in particular be part of the inlet container. By means of interaction between the first pressing element and the second pressing element, the pressing section can be formed and a filter pad arranged in the receiving region can be pressed together in the radially outer area of the receiving region.

One advantage of such a device is that a filter pad can be easily held in the device. For this purpose, the filter pad can be inserted into the receiving region provided for this purpose and then the pressing section can be provided by means of the pressing elements, whereby the received filter pad is held securely and cannot slip even during use of the device. Inserting a filter pad into such a device and replacing a filter pad in such a device is therefore possible within a short time and incorrect operation is largely ruled out.

A further advantage is that the filter pad can be reliably pressed radially at the outer diameter between the first pressing element and the second pressing element by means of the pressing section and thus held unmoved in the optimum position for filtration. The pressing section can fix filter pads with differing thicknesses that are within a tolerance range in a particularly advantageous way. If, for example, a filter pad is produced with a manufacturing tolerance in the range of +2 mm, reliable fixing of the filter pad in the pressing section can be ensured regardless of the exact thickness of the filter pad. This means that filter pads of different sizes can be laid or inserted into the receiving region without having to adapt the filter pad or the device.

According to a particularly preferred embodiment, the device comprises an inlet container for receiving water to be purified, wherein the inlet container is detachably connected to the connecting portion of the frame, wherein preferably the second pressing element is formed integrally with the inlet container. In particular, an inlet container is to be understood as a container in which water to be purified can be held. The inlet container can also be referred to as a reservoir. The inlet container can be detachably connected to the connecting portion of the frame. A second pressing element formed integrally with the inlet container offers the advantage that the second pressing element is necessarily arranged in the correct position after the inlet container and frame have been connected in order to form the pressing section with the first pressing element, without the second pressing element having to be positioned separately.

It is particularly preferred that the connecting portion of the frame has at least one bayonet element, preferably several, in particular three, bayonet elements, wherein preferably the at least one bayonet element is arranged on the inside of the frame, wherein preferably the inlet container has at least one bayonet mount, preferably several, in particular three bayonet mounts, for receiving the at least one bayonet element.

It is therefore proposed that the frame is part of a bayonet lock and can be detachably mechanically coupled to a counterpart. A bayonet lock is known in principle. It is preferred if the inlet container has at least one bayonet mount as a counterpart. A bayonet mount can also be understood as the groove of a bayonet lock. It is therefore proposed that the frame or the filter holder is screwed to a filling container or inlet container of a table water filter, for example, by means of a bayonet lock.

In a particularly preferred embodiment, the at least one bayonet element is arranged on the inside of the frame. It is particularly preferred if the frame has three bayonet elements that are designed to be received in three bayonet mounts of the inlet container.

It is particularly preferred that the outlet opening is arranged centrally in the holding element in the radial direction and is smaller than the inlet opening. Preferably, the inlet opening is many times smaller than the inlet opening. A centrally arranged outlet opening enables a controlled and centered water outlet from the device.

It is particularly preferred that the holding element has radially arranged webs, wherein channels are formed between the webs of the holding element, which are radially aligned and extend in the direction of the outlet opening, wherein the webs of the holding element preferably have a decreasing height in the direction of the outlet opening. The radially arranged webs preferably extend from the first pressing element to the outlet opening. In particular, the webs can serve as a support surface for the filter pad in the lower area of the receiving region. In particular, the webs can be arranged in such a way that a filter pad arranged in the receiving region rests on the webs. By means of such webs, an improved flow of water through the filter pad to the outlet opening can be provided, as water that has passed through the filter pad can flow directly to the outlet opening due to the channels formed by the webs. This means that an improved cleaning speed can be achieved by means of the webs and the channels formed by the webs, i.e. the volume of water filtered by the device can be increased per unit of time.

It is particularly preferred that a flow limiter for limiting a quantity of water is arranged in the region of the inlet opening of the holding element, the flow limiter preferably having a plurality of flow-through holes, wherein preferably the flow limiter is formed integrally with the inlet container. In particular, a flow limiter means an element that restricts the flow rate of water, in particular water that has not yet been purified. The flow limiter can, for example, be designed as a grid with a predefined passage area, as a hydraulic throttle, as an orifice or similar. Preferably, the flow limiter is formed by a surface with several flow-through holes. In particular, the flow limiter limits the water flow to a specific value. A flow limiter can also be referred to as a surge brake. In particular, the flow limiter can be used to protect a filter pad arranged in the receiving region. By means of such a flow limiter, a flow rate of the water required for an optimum filtration process can be achieved.

It is particularly preferred that webs are arranged between the flow-through holes of the flow limiter on the side of the flow-through holes facing the receiving region, which webs form channels that are aligned in the direction of the outlet opening, wherein the webs of the flow limiter preferably have a decreasing height in the radial direction in the direction of the outlet opening. By means of such webs, a flow direction in the upper area of the receiving region radially inwards can be made possible. Such webs can also serve to limit the receiving region in the upper area of the receiving region, so that a filter pad received in the receiving region is held by the webs in the upper area of the receiving region.

It is particularly preferred that the flow limiter has at least six, preferably at least ten, in particular at least sixteen flow-through holes. Preferably, the flow limiter has at most forty, preferably at most thirty, in particular at most twenty flow-through holes. Particularly preferably, the flow limiter has eighteen flow-through holes.

It is particularly preferred that the frame and the holding element are connected to one another, in particular with a material connection, wherein the frame and the holding element are preferably integrally formed.

It is particularly preferred that the inlet container has a sealing projection, which is in particular formed integrally with the inlet container, wherein the sealing projection bears radially circumferentially against the holding element in order to form a fluid-tight connection between the inlet container and the holding element. Preferably, the sealing projection forms a fluid-tight connection with the holding element between the inlet container and the holding element. This prevents water from entering an area in the frame radially outside the holding element. In particular, the sealing projection provides a radially circumferential conical seal between the holding element and the inlet container, thus preventing unfiltered water from escaping laterally.

It is particularly preferred that the sealing projection and the second pressing element extend parallel to one another, are arranged radially circumferentially and form a radially circumferential channel located therebetween. The sealing projection is preferably arranged further outwards in the radial direction than the second pressing element.

It is particularly preferred that the inlet opening and the outlet opening are arranged on opposite sides of the receiving region in the flow direction. In particular, the inlet opening and the outlet opening are located on opposite sides of a filter pad accommodated in the receiving region.

According to a further aspect, a device according to claim 13 is proposed.

The frame and the holding element together form a filter holder.

The filter holder therefore comprises a frame. The frame is structurally rigid and preferably made of plastic. However, other structurally stable materials such as metal, painted wood, solid silicone, composite materials or the like can also be used for the frame. The frame serves as a supporting structure for the components of the filter holder. The frame can be of any shape, for example round or square. In a preferred embodiment, the frame is ring-shaped. The frame can also be understood and referred to as a holding frame or housing.

The filter holder therefore also comprises an elastic holding element. The elastic holding element is suitable for holding a filter pad. The holding element can also be understood and described as a filter seat. The filter pad is inserted or laid into the elastic holding element. The elastic holding element is held by the frame. The elastic holding element is thus mechanically attached to the frame, for example by a clamping connection or screw connection or the like. The holding element is therefore an element that holds the filter pad mechanically and is fixed to the frame. The holding element can therefore also be understood as a holder for the filter pad or as a filter seat. The holding element is designed to be elastic, i.e. flexibly deformable. For this purpose, the elastic holding element can be made of an elastically deformable material, such as rubber, silicone or the like.

The holding element and the frame have an inlet opening and an outlet opening. The inlet opening is an opening or recess at which unfiltered water enters the holder or the holding element. The outlet opening is an opening or recess at which filtered water exits the holder or holding element. The inlet opening and the outlet opening can also be understood as the inlet side or outlet side or as the inlet or outlet. It is understood that both the frame and the elastic holding element each have an inlet opening and an outlet opening, which, for example, are spatially located at the same position or location, since the filter holder mechanically holds the elastic holding element.

In addition, a flow direction is formed from the inlet opening to the outlet opening. The flow direction describes a direction in which the water flows or seeps through the filter holder during predetermined operation and can also be understood as a direction of flow.

It is also provided that the elastic holding element has a fixed end and a free end and that the holding element is mechanically connected to the frame at the fixed end. The fixed end is therefore a point or an area at which the elastic holding element is mechanically coupled to the frame. The fixed end can be mechanically connected to the frame in a detachable or fixed manner. For example, the fixed end of the elastic holding element can be fixed to the frame with a clamping connection or a crimp connection. The free end can be understood as a movable end of the elastic holding element. The fixed end and the free end thus refer to the structural ends or terminations of the elastic holding element.

Several advantages are achieved with this design of filter holder. Due to the mobility of the free end of the holding element, mobility of the holding element is achieved. The mobility of the elastic holding element is advantageous because the filter holder adapts to filter pads of different sizes. For example, if a filter pad is produced with a manufacturing tolerance in the range of ±2 mm, the elastic holding element adapts to filter pads of different sizes due to the free end and the elastic deformability of the holding element. This means that filter pads of different sizes can be inserted into the filter holder without having to adjust the filter pad. Due to the elasticity of the elastic holding element, it adapts to the different sizes and tolerances of the inserted filter pad. This also minimizes the risk of damage to the filter pad during Inserting. The elastic holding element also seals the filter pad well due to its elastic properties.

Preferably, the elastic holding element is formed from an elastic material that has a Shore A hardness in a range from 20 to 70. The Shore A hardness is a known value for the hardness of an elastic material. In a particularly preferred embodiment, the Shore A hardness is in a range of 20 to 40, in particular in a range of 30-35.

Preferably, the elastic holding element is made of an elastic material, wherein the elastic material is silicone, a thermoplastic (TPU), a thermoplastic elastomer (TPE) or rubber or the like.

The elastic holding element can be made entirely or partially from the elastic material.

Preferably, the elastic holding element forms a press connection with one or more of the filter pads in a joined state. The joined state refers to a state in which a filter pad is held or inserted in the filter holder. In the joined state, the elastic holding element exerts a pressing force on the filter pad. The pressing force is in particular a radial pressing force as well as an axial force.

In a particularly preferred embodiment, the elastic holding element exerts a holding force on the filter pad, the holding force being selected to be greater than or equal to a mass of water in contact with the filter pad, wherein the holding force is determined in particular by a water level in a reservoir connected in a fluid-conducting manner to the filter holder and the mechanical properties of the filter pad.

The elastic holding element fulfills two functions.

On the one hand, the elastic holding element should grip or hold the filter pad cleanly around its outer surface and should compensate for tolerances in the filter pad.

It is therefore suggested that a surface pressure be set as low as possible on the outer surface of the filter pad in order not to compress the filter material of the filter pad too much, but to keep the filter pad wrapped around in order to avoid bypass flows. A bypass flow or bypass water flow is an unwanted and unfiltered water flow that flows past the filter or filter pad.

The elastic part of the holder, i.e. the elastic holding element, which is made of silicone, for example, absorbs or compensates for production-related diameter tolerances. Due to the elasticity of the elastic holding element, it fits snugly against the wall/shell surface of the filter or filter pad.

Preferably, the elastic holding element forms a bead-like shape for mechanical fixation of the filter pad in the region of the outlet opening after mounting and compression thereof on a or the receiving portion. In other words, it is proposed that the filter holder is designed in such a way that the receiving portion is deformed in the area of the outlet opening in such a way that the receiving portion at least partially grips the filter pad in order to secure the filter pad from slipping out in the flow direction. The receiving portion can also be referred to as the lower bevel. The bead-like shape can be understood as a deformation of the elastic holding element or its receiving portion. The bead-like shape can also be referred to as a bulge or protrusion, which is created in the area of the outlet opening, i.e. on the underside of the filter holder in the mounted state. The bead-like shape is created in particular due to the compression of the receiving portion along a or the compression slope or surface. It is therefore proposed that the filter holder is designed with a compression slope or compression surface such that the receiving portion is deformed in the area of the outlet opening in such a way that the receiving portion at least partially grips around the filter pad in a mounted state in order to secure the filter pad from slipping out in the flow direction.

This characteristic represents a surface pressure or force on the filter, depending on the thickness of the filter, e.g. 7 mm or 10.5 mm. This characteristic, which can also be described as a bead-like characteristic, serves to protect the filter against breakthrough or push-out in the flow direction of the filtered water. This holding force is determined by the water level of an upper reservoir and the mechanical properties of the filter pad, and should be greater than or equal to the aforementioned adjacent water mass.

In summary, it is suggested that surface pressure is kept as low as possible or necessary in order to ensure that the filter functions properly.

A pressing force in this value range is particularly advantageous, as the filter pad is not compressed too much. Excessive compression would change the flow properties of the filter pad. On the other hand, the filter pad is held with a sufficient pressing force to prevent it from slipping out of the elastic holding element. The lower value of the pressing force in the value range described above therefore corresponds to a minimum pressing force that is required to hold the filter pad. The upper value of the pressing force in the value range described above therefore corresponds to a maximum pressing force at which the properties of the filter pad are not changed or the filter pad is not compressed too much. If the filter pad is compressed too much, the filter pad is compressed, which leads to changes in the flow properties of the filter pad. For example, the flow rate of the water through the filter pad changes depending on the compression.

Preferably, the elastic holding element has a receiving portion that extends from the fixed end in the direction of the free end, wherein the receiving portion tapers in the opposite direction to the flow direction. The taper can be linear or curved, e.g. convex or concave. However, the taper can also have a profile, i.e. a mixture of the shapes described above. The receiving portion is therefore a section into which the filter pad is inserted. It is preferably inserted in the opposite direction to the flow direction. The receiving portion with such a shape facilitates the Inserting and placement of a filter pad in the elastic holding element.

Additionally or alternatively, the elastic holding element also has a sealing section. The sealing section is a section at which the elastic holding element and a filter pad or the filter pad it holds are in direct contact. The sealing section ensures that the water to be cleaned flows completely and exclusively through the filter pad and does not flow past the filter pad unfiltered. It is understood that the sealing section is also determined by the shape of the filter pad. Preferably, the sealing section runs essentially parallel to the flow direction.

In a particularly preferred embodiment, the sealing section adjoins the receiving portion. It is therefore proposed that, starting from the fixed end of the elastic holding element, the tapered receiving portion follows first and then the sealing section.

Preferably, the free end of the holding element has a limiting projection to limit the Inserting of the filter pad into the holding element. A limiting projection prevents the filter pad from slipping completely through the elastic holding element and can be easily positioned in the holding element. The limiting projection is therefore part of the elastic holding element. The limiting projection can also be understood as a stop. The limiting projection can also be understood as a holding lip. The limiting projection is arranged on the lower mold slope, i.e. on the free end of the holding element. The limiting projection additionally secures the tensioned filter against slipping out and holds it in position.

Preferably, the free end has a sealing groove. In a particularly preferred embodiment, the sealing groove is aligned against the flow direction at the free end. The sealing groove serves to accommodate a sealing lip, for example a sealing lip of a flow limiter or of components to which the filter holder is mounted. The groove can also be seen as a double sealing lip. The groove or double sealing lip can thus form a watertight transition with a counterpart on a filling container or an inlet container and is secured against slipping by the sealing guide.

Preferably, the holding element is detachably mechanically connected to the frame at the fixed end. It is therefore proposed that there is a detachable mechanical connection between the elastic holding element and the frame. This allows the holding element to be removed and cleaned.

This allows the filter element to be inserted externally and more easily. It can also be replaced if damaged. Detachable mechanical connections can be provided to connect the fixed end to the frame, such as detachable clamping connections, detachable screw connections, detachable crimp connections or the like.

Preferably, the fixed end has two opposing fastening projections for mechanically fastening the elastic holding element to the frame. This prevents the holding element from slipping out of the mechanical connection with the frame.

Preferably, a deflection area is formed between the frame and the elastic holding element. The deflection area is formed, for example, as an empty or air-filled space between the elastic holding element and the frame or the like. The elastic holding element can thus move into the deflection area in order to compensate for different diameters of the filter pad.

Preferably, the frame has a compression portion having a compression surface, wherein the compression surface faces the holding element and the elastic holding element is designed to be arranged by deformation along the compression surface. It is therefore proposed that the elastic holding element can be arranged along the compression surface by the application of a force that causes mechanical deformation of the elastic holding element. Under the effect of force, the elastic holding element thus deforms and lies on the compression surface. The fact that the elastic holding element is designed to be deformable means that the holding element is partially deformed along the compression surface. The deformation of the elastic holding element and its contact with the compression surface compresses the filter or filter pad and prevents it from slipping out. This allows the filter pad to be held securely in the holding element. In addition, the filter pad is not compressed too much and the flow properties do not change.

In a particularly preferred embodiment, the compression portion tapers in the flow direction. The taper can be linear or curved, e.g. convex or concave. However, the taper can also have a profile, i.e. be a mixture of the curves described above.

A longitudinal axis also preferably extends along the flow direction and the compression surface is aligned at an acute angle in relation to the longitudinal axis. In this embodiment, the compression surface is at least partially linear and meets the longitudinal axis at an acute angle.

In a particularly preferred embodiment, the compression surface is aligned in relation to the longitudinal axis at an angle from an angular range of 10° to 80°, in particular at an angle from an angular range of 30° to 60°.

Preferably, the inlet opening and the outlet opening are arranged opposite each other in the flow direction. It is therefore suggested that the inlet and outlet are opposite each other.

Preferably, the frame is formed in several parts and the frame comprises a holding ring comprising a compression portion. It is therefore proposed that the frame is formed from at least two parts, one part being a holding ring. The holding ring comprises a compression portion, in particular as described above, with a compression slope.

In a particularly preferred embodiment, the holding ring forms a clamping connection with a frame part for the fixed end of the elastic holding element. Such a multi-part frame is advantageous because the ring can be removed from the rest of the frame or the frame part for cleaning purposes. It also allows the elastic holding element to be replaced in the event that the elastic holding element is damaged. This element can also be designed as a two-component injection molding.

Preferably, the holding frame is formed with a bayonet mount for receiving a bayonet counterpart. It is therefore proposed that the holding frame is part of a bayonet lock and can be mechanically coupled with a counterpart. A bayonet lock is known in principle. The bayonet mount can also be understood as a groove of a bayonet lock. It is therefore proposed that the filter holder is screwed to a filling container or inlet container of a table water filter, for example, by means of a bayonet lock. It is understood that the inlet container has, for example, a bayonet counterpart that matches the bayonet mount.

In a particularly preferred embodiment, the bayonet mount is arranged on the inside of the frame.

Preferably, a flow limiter is arranged on the inlet side to limit the amount of water. The flow limiter can, for example, be designed as a grid with a predefined passage area, as a hydraulic throttle, as an orifice plate or the like. The flow limiter can be part of the frame or part of a counterpart connected to the frame. The flow limiter limits the water flow to a predetermined value.

According to a further aspect of the invention, a filter system for water purification with a filter holder and a filter pad is proposed, wherein the filter pad for water purification is held in the filter holder and the filter holder is formed according to one of the above embodiments. A filter system is thus proposed which is suitable for water purification and has a filter holder and a filter pad for this purpose.

The advantages, explanations and definitions of the filter holder described above apply analogously to the filter system described above and vice versa.

According to a further aspect of the invention, a table water filter with an inlet container and an outlet container is proposed, wherein the inlet container and the outlet container are connected to one another in a fluid-conducting manner via a filter system. The filter system is designed according to one of the above embodiments or the table water filter has a filter holder which is designed according to one of the above embodiments. Contaminated water is let into or filled into the inlet container. The water then flows or seeps through the filter system and is cleaned in the process. The impurities remain in the filter system and the cleaned water can be removed from the outlet container.

The advantages, explanations and definitions of the filter holder and filter system described above apply analogously to the table water filter described above and vice versa.

Preferably, the inlet container of the table water filter has a flow limiter for limiting the amount of water on one inlet side of the filter holder.

According to a further aspect of the invention, a method of manufacturing a filter holder for receiving a filter pad for water purification is proposed, comprising the steps of: providing a frame; providing an elastic holding element, wherein the elastic holding element has a fixed end and a free end, and wherein the holding element and the frame have an inlet opening and an outlet opening and a flow direction is formed from the inlet opening to the outlet opening; and mechanically connecting the holding element at the fixed end to the frame to hold the elastic holding element in the frame.

In a first alternative embodiment, a filter holder for receiving a filter pad for water purification is proposed, in particular for receiving an activated carbon filter pad, namely a clamping holder, wherein the clamping holder is formed from a plurality of hard jaws and from a plurality of soft jaws, wherein the hard jaws have a greater elasticity than the soft jaws, and wherein the clamping holder is annular in shape in order to provide an annular collet for receiving the filter pad, and wherein the filter pad in a joined state separates an inlet opening and an outlet opening of the clamping holder in a fluid-conducting manner. The jaws are preferably connected by means of 2-component injection molding. By moving the hard jaws, it is possible to insert a filter pad into the clamping holder due to the elasticity of the soft jaws.

In a second alternative embodiment, a filter holder for receiving a filter pad for water purification is proposed, in particular for receiving an activated carbon filter pad, namely a squeeze holder, wherein the squeeze holder is formed from a structurally rigid frame and the frame forms a press fit into which a filter pad can be pressed, wherein the squeeze holder also has a conical opening which forms a receiving portion and wherein the squeeze holder also has a sealing section which runs parallel to a flow direction, wherein the flow direction extends from an inlet opening to an outlet opening of the squeeze holder, which forms a receiving portion and wherein the squeeze holder also has a sealing section which runs parallel to a flow direction, wherein the flow direction extends from an inlet opening to an outlet opening of the squeeze holder, and wherein the filter pad in a joined state separates the inlet opening and the outlet opening of the squeeze holder in a fluid-conducting manner. The basic principle of the squeeze holder is that the filter pad is pressed in through the conical opening and the conical geometry of the holder presses the filter pad together and holds it in an end position.

In a third alternative embodiment, a filter holder for receiving a filter pad for water purification is proposed, in particular for receiving an activated carbon filter pad, namely a polygon holder, wherein the polygon holder is formed from a structurally rigid frame and the frame forms a press fit into which a filter pad can be pressed, and wherein the polygon holder has a polygon-shaped opening which forms a receiving portion and wherein the polygon holder also has a sealing section which runs essentially parallel to a flow direction, wherein the flow direction extends from an inlet opening to an outlet opening of the polygon holder, which forms a receiving portion and wherein the polygon holder also has a sealing section which runs essentially parallel to a flow direction, wherein the flow direction extends from an inlet opening to an outlet opening of the polygon holder, and wherein the filter pad in a joined state separates the inlet opening and the outlet opening of the polygon holder in a fluid-conducting manner. The basic principle of the polygon holder is that the filter pad is pressed in through the polygon-shaped opening and the polygon-shaped geometry of the holder presses the filter pad together and holds it in an end position. When pressed in, the filter pad is given the same geometry as the curved inner contour of the sealing section. This reduces creases at the edge of the filter pad.

In order not to destroy the filter pad in the second and third embodiment, it is proposed to apply the pressure over the entire surface of the filter pad in the flow direction.

In a fourth alternative embodiment, a filter holder for receiving a filter pad for water purification is proposed, in particular for holding an activated carbon filter pad, namely a lamella holder, wherein the lamella holder has a plurality of deformable lamellae which are arranged in an annular opening of a structurally rigid frame of the lamella holder in order to form a lamella receptacle for holding the filter pad and in order to compensate for filter tolerances of the filter pad, wherein the lamellae are formed from an elastic material, in particular silicone, and wherein the lamellae are deformable so that the lamellae are deformed when a filter pad is pressed into the lamella holder and the pressed-in filter pad is fixed in the lamella holder, and wherein the filter pad separates an inlet opening and an outlet opening of the lamella holder in a fluid-conducting manner in a joined state. The basic principle of the lamella holder is therefore that it has a sealing section with deformable lamellae, which are bent when the filter pad is pressed in and seal the filter pad. Different lamellas can be provided depending on the thickness of the filter pad.

In a fifth alternative embodiment, a filter holder for receiving a filter pad for water purification is proposed, in particular for receiving an activated carbon filter pad, namely a cutting clamp holder, wherein the cutting clamp holder comprises a clamping lid and a clamping lid receptacle, and wherein the clamping lid has a receiving opening for placing a filter pad in the clamping lid, and wherein the clamping lid receptacle has an opening with a cutting edge, wherein a diameter of the opening is smaller than a diameter of a filter pad placed in the clamping lid, and wherein the clamping lid and the clamping lid holder are designed to be screwed together, and wherein the filter pad placed in the clamping lid separates an inlet opening and an outlet opening of the cutting clamp holder in a fluid-conducting manner in a joined state when the clamping lid and the clamping lid holder are screwed together. The basic principle of the cutting clamp holder is therefore that the filter pad is pre-positioned in the clamping lid and is then pressed against the clamping lid. During pressing, the cutting edge of the clamping lid holder cuts into the filter pad and ensures that it is firmly positioned in the holder. Tolerances on the diameter of the filter pad can thus be compensated for, as a defined part of the filter is clamped off and used.

A further aspect of the invention relates to an activated carbon filter for drinking water purification and a use of an activated carbon filter for drinking water purification.

According to the invention, an activated carbon filter for drinking water purification is proposed for solving the task mentioned at the beginning, wherein the activated carbon filter is made of activated carbon fiber and has a filter diameter and a filter thickness, wherein the filter diameter is in a range from 65 millimeters to 75 millimeters, and the filter thickness is in a range from 6 millimeters to 12 millimeters.

The activated carbon filter for drinking water purification is made of activated carbon fiber and has a filter diameter and a filter thickness. Accordingly, no activated carbon filter is proposed that works with activated carbon in the form of granules, as a powder or in pelletized form, but rather an activated carbon filter for water purification is proposed that is made from a fabric of activated carbon. This fabric is also known as activated carbon fleece.

There is a technical connection between the device and the activated carbon filter in that the activated carbon filter is designed precisely by its special configuration to be received in the device in the receiving region provided for this purpose and the filter formed from activated carbon can be detachably inserted into the receiving region. The pressing section of the device is precisely adapted to the design of the activated carbon filter so that the device and the activated carbon filter can interact in a particularly advantageous way.

The filter diameter and the filter thickness are essential for the functioning of the activated carbon filter for drinking water purification. A filter diameter in the range of 65 millimeters to 75 millimeters is proposed. A filter thickness in the range of 6 millimeters to 12 millimeters is also proposed.

The activated carbon filter can be used in various devices for drinking water purification, for example in table water filters, which are also known as can systems.

Preferably, the filter thickness is in the range of 6.5 millimeters to 7.5 millimeters. In a particularly preferred embodiment, the filter thickness is around 7 millimeters.

In an alternative embodiment, the filter thickness is in the range of 10 millimeters to 11 millimeters. In a particularly preferred embodiment, the filter thickness is approximately 10.5 millimeters.

It was recognized that the proposed ranges for filter thickness and filter diameter provide a good compromise between filtration speed and purification effect.

If a filter thickness greater than that suggested is selected, the flow rate decreases and the purification effect hardly changes. If a filter thickness smaller than the suggested one is selected, the flow rate increases but the purification effect is too low.

A filter diameter in the suggested range provides a sufficiently large, but not too small, passage area for the liquid to be purified in order to efficiently purify drinking water. The suggested range is particularly suitable for table water filters.

Preferably, the activated carbon filter has an ion exchanger formed with polyacrylate. Ion exchangers are generally known. Ion exchangers or ion exchangers are materials with which dissolved ions can be replaced by other ions of the same charge. Polyacrylates (polyacrylic acid esters) are proposed here as ion exchangers. Polyacrylates are polymers produced from esters of acrylic acid (acrylic acid esters) and polyacrylates are generally known.

Preferably, the activated carbon filter has a binder that is formed with polyester. Binders are substances that create or promote chemical bonds at the phase boundaries of other substances or trigger or increase effects such as cohesion, adsorption and adhesion or friction. They combine substances by absorbing, attaching, holding together, cross-linking or bonding them. Polyester is proposed here as a binder. Polyesters are polymers with ester functions in their main chain and polyester is generally known.

The shape of the activated carbon filter is basically arbitrary, i.e. the filter can be round or disk-shaped, angular or honeycomb-shaped or the like. Preferably, the activated carbon filter is disk-shaped. A disk shape is particularly advantageous for cylindrical table water filters, as the filter surface is utilized to the maximum.

Preferably, the activated carbon filter has an intrinsic weight of less than 10 grams. The low weight of the activated carbon filter, which is only made of activated carbon fibers, enables resource-saving transport, easy handling and is particularly suitable for table water filters that are moved manually.

Preferably, the activated carbon filter has a filtration rate of less than 1 liter per two minutes. Less means that the time required by the activated carbon filter to purify one liter of liquid or water is less than two minutes. The unit of measurement for the filtration speed is therefore defined as liters per minute. It is understood that, converted to one minute, the filtration speed is 0.5 liters per minute. Due to the proposed filter material with activated carbon fibers, the proposed filter thicknesses and the proposed filter diameter, a high filtration speed or filtration performance is achieved with a sufficient purifying effect.

Preferably, the activated carbon filter is formed exclusively of activated carbon fiber, the ion exchanger and the binder. It is therefore preferably proposed that the filter holder is designed, for example, without a disposable plastic housing or the like.

Preferably, the activated carbon filter is designed to mineralize or add the additives to liquid filtered through or by means of additives introduced into the activated carbon filter. The liquid is preferably water. It is therefore proposed that additives are added to the activated carbon filter, such as minerals, flavorings, electrolytes or the like. This ensures that the additives are released into the liquid during filtration and that the purified drinking water is enriched with the additives.

Preferably, the activated carbon filter has two layers, wherein a first layer is formed of activated carbon fibers, a binder and an ion exchanger, and a second layer is formed with additives introduced in order to mineralize or add the additives to the liquid filtered by the first layer by means of the second layer. Thus, an activated carbon filter made of activated carbon fibers with two layers is proposed. The first layer can be understood as a purification layer and it is designed and intended to purify liquid. The second layer can be understood as an additional layer, in the sense of adding. This layer does not require any water filtration and can also be understood as a delivery layer for the additives. The additives can be minerals, flavorings, electrolytes or the like. A particular advantage of the separation of the two layers is that the first layer does not directly filter out the additives introduced.

Preferably, the second layer has a different color than the first layer. This allows the two layers to be visually differentiated and, for example, the color of the second layer can be matched to certain additives. For example, if a second layer is formed with a “raspberry” flavoring, the second layer can be raspberry-colored. This also makes it visually apparent which side of the activated carbon filter is purifying and which is releasing the additives. This reduces incorrect inserting of the activated carbon filter.

The additives are particularly preferably minerals. In a particularly preferred embodiment, the minerals are magnesium, calcium, zinc and/or iron or the like.

The additives are particularly preferably flavorings.

The additives are particularly preferably electrolytes. In a particularly preferred embodiment, the electrolytes are sodium, potassium, chloride and bicarbonate. According to a further aspect of the invention, a use of an activated carbon filter for drinking water purification is proposed, wherein the activated carbon filter is formed according to one of the preceding embodiments.

According to a preferred embodiment, a filter holder with an activated carbon filter is proposed, wherein the activated carbon filter is designed according to one of the above embodiments. The filter holder is to be understood as a holder or insert for the activated carbon filter, with which the drinking water purification is carried out. The activated carbon filter is laid or inserted into the filter holder. It is understood that the filter holder has an inlet side and an outlet side and that the inlet side and the outlet side are separated by the activated carbon filter to ensure purification of the liquid. For example, water is purified to obtain drinkable or filtered water.

According to a preferred embodiment, a table water filter with an activated carbon filter is proposed, wherein the activated carbon filter is designed according to one of the above embodiments. Table water filters are generally known and are also known as can systems. The table water filter has two separate containers which are separated from each other by the activated carbon filter. The two containers are connected to each other in a fluid-conducting manner via the activated carbon filter. This allows the liquid to be purified to be poured into the first container, the liquid to seep through the activated carbon filter and be poured out of the second container.

According to a further aspect, the task mentioned at the beginning is solved by a table water filter, comprising a device as described here, wherein a filter pad is preferably inserted into the device, an outlet container, preferably comprising or consisting of glass, wherein the inlet container can be inserted into the outlet container, in particular detachably. In particular, the inlet container can be designed to be positively connectable to the outlet container, for example by means of a ring snap connection, in particular by means of a segmented ring snap connection, which can be arranged, for example, at the upper edge of the outlet container.

According to a further aspect, the task mentioned at the beginning is solved by a filter system for water purification, comprising a device as described here and/or a table water filter as described here, and a filter pad, wherein the filter pad for water purification is held in the receiving region of the device.

According to a further aspect, the task mentioned at the beginning is solved by a method for purifying water, comprising the steps: Providing a device as described herein, inserting a filter pad into the receiving region, connecting the frame to the inlet container, inserting the inlet container into an outlet container, filling water to be cleaned into the inlet container. Preferably, the steps are carried out in the specified order. After the water to be cleaned has been filled in, the water can in particular flow from the inlet container through the filter pad into the outlet container, so that cleaned water is present in the outlet container. The purified water present in the outlet container can then be poured out of the outlet container, for example into a glass. Preferably, the method further comprises replacing the filter pad, in particular after a predetermined time and/or a predetermined amount of water has passed through the filter pad.

According to a further aspect, the task mentioned at the beginning is solved by using a device with a received filter pad, in particular in the form of a filter system as described here, for water purification, the device being designed as described here.

With regard to the advantages, embodiment variants and embodiment details of the various aspects of the solutions described herein and their respective possible embodiments, reference is also made to the description of the corresponding features, details and advantages of the respective other aspects and their embodiments.

Preferred embodiments are explained by way of example with reference to the accompanying figures. The drawings are not necessarily true to scale. In the figures, identical or essentially functionally identical or similar elements are designated with the same reference symbols. They show:

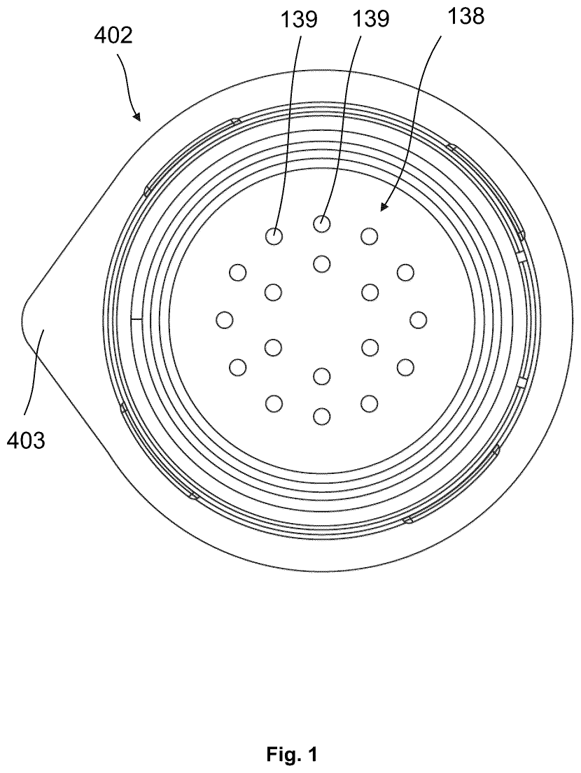

FIG. 1: a schematic top view of an inlet container;

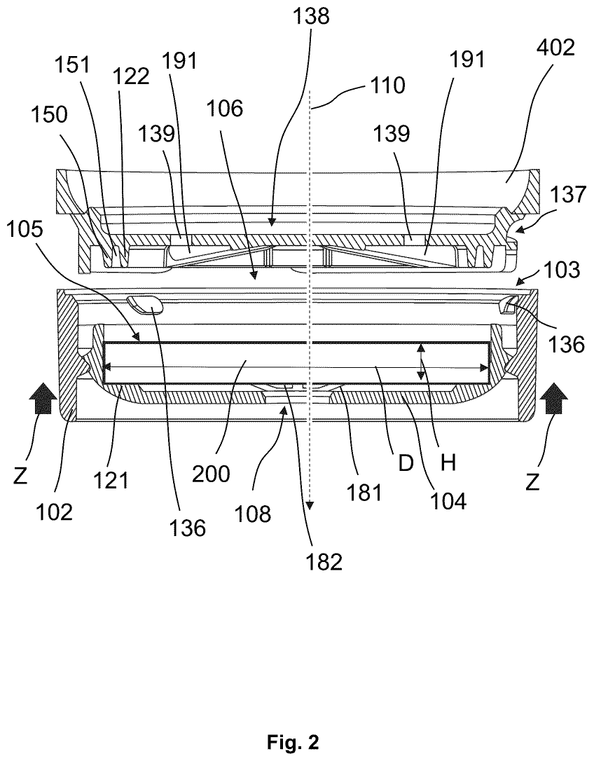

FIG. 2: a schematic sectional view of a device for holding a filter pad with a frame, a holding element and an inlet container, wherein in this view the inlet container and the frame are not connected to each other;

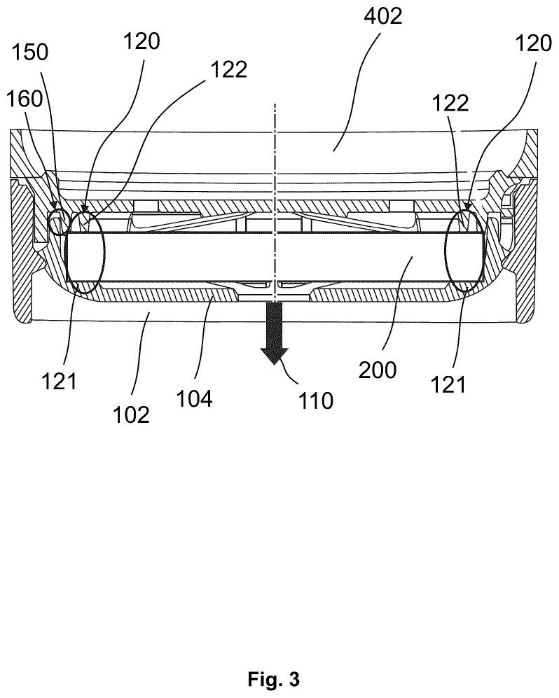

FIG. 3: a schematic sectional view of a device for holding a filter pad with a frame, a holding element and an inlet container, wherein in this view the inlet container and the frame are connected to each other;

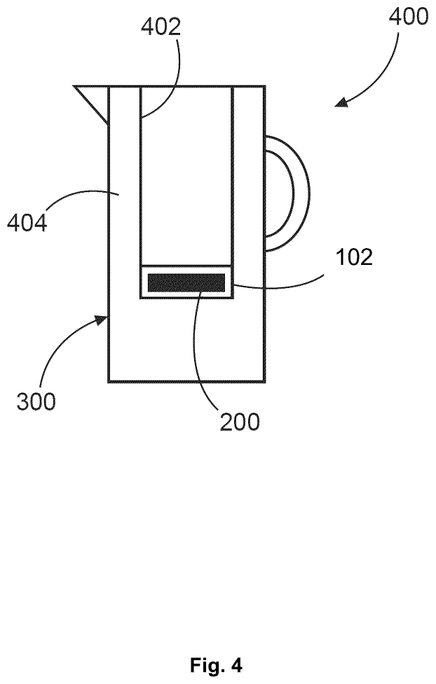

FIG. 4: a highly simplified schematic representation of a table water filter;

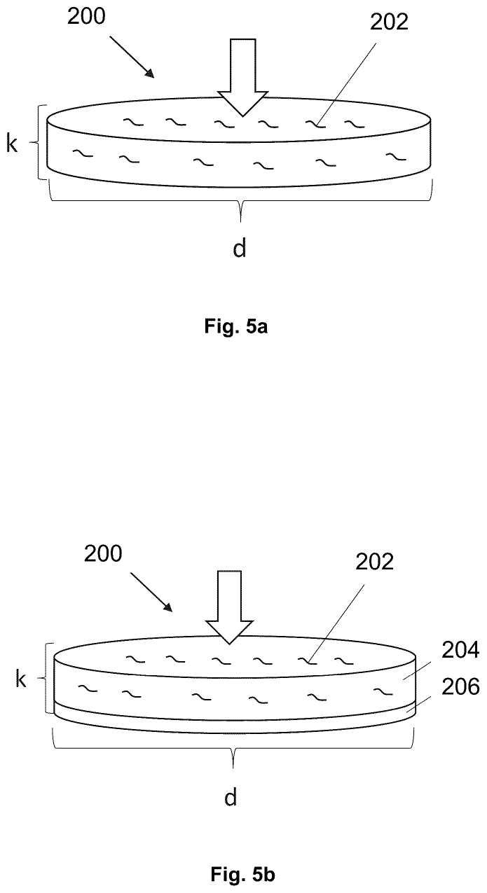

FIG. 5a: a first embodiment of a filter pad for insertion into a device for holding a filter pad;

FIG. 5b: a second embodiment of a filter pad for inserting into a device for holding a filter pad;

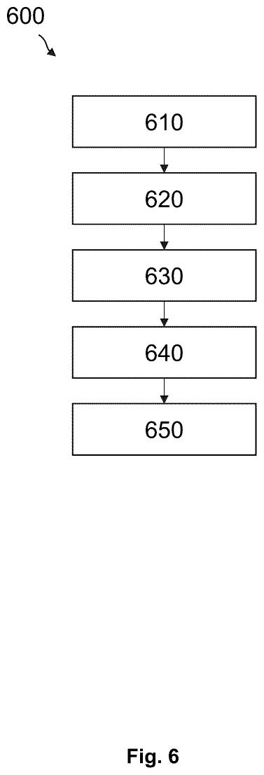

FIG. 6: a schematic representation of a process for purifying water,

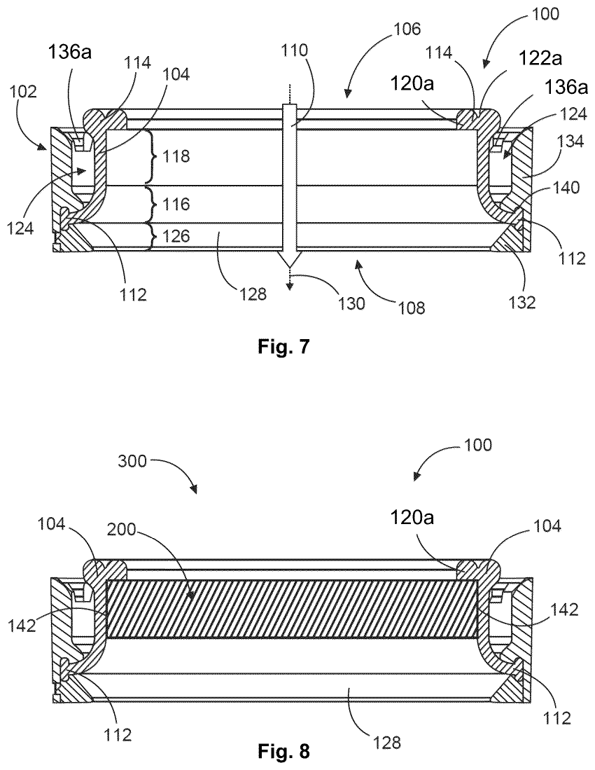

FIG. 7 shows a sectional view of a filter holder.

FIG. 8 shows a sectional view of a filter holder with a filter pad or a filter system.

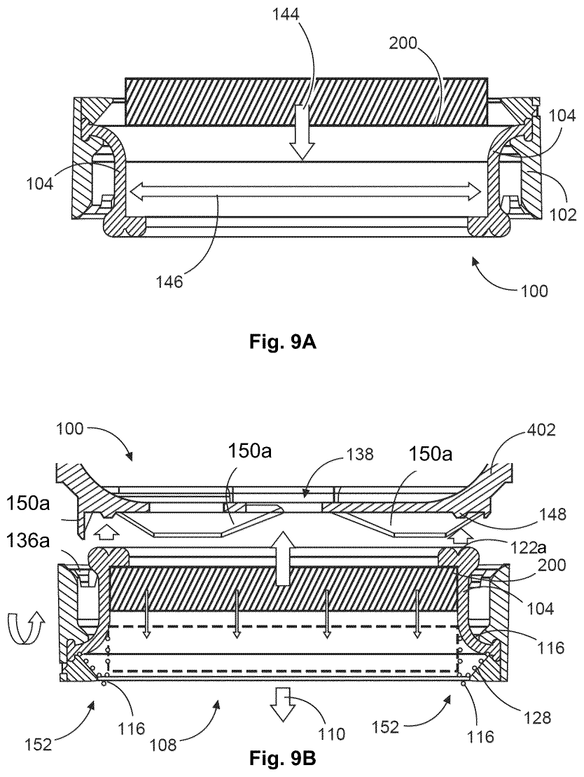

FIGS. 9A, B show a sectional view of a filter holder and illustrate the insertion of a filter pad into a filter holder in one embodiment.

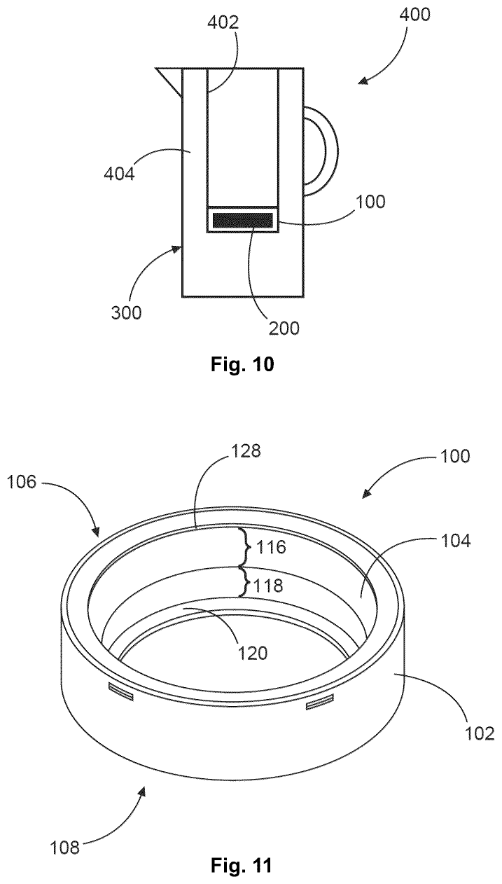

FIG. 10 shows a table water filter with a filter holder in one embodiment.

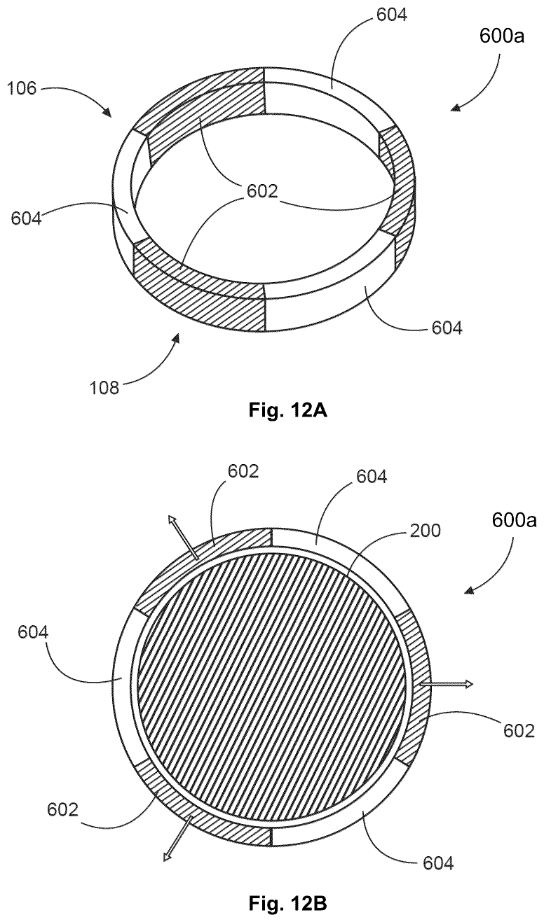

FIG. 11 shows a perspective view of a filter holder in a further embodiment.

FIGS. 12A, B show a filter holder in a first alternative embodiment.

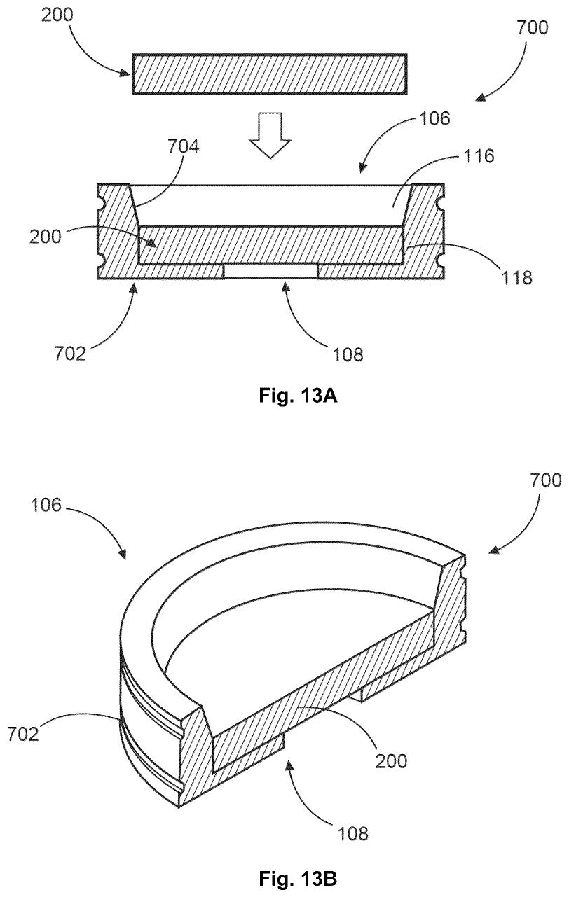

FIGS. 13A, B show a filter holder in a second alternative embodiment.

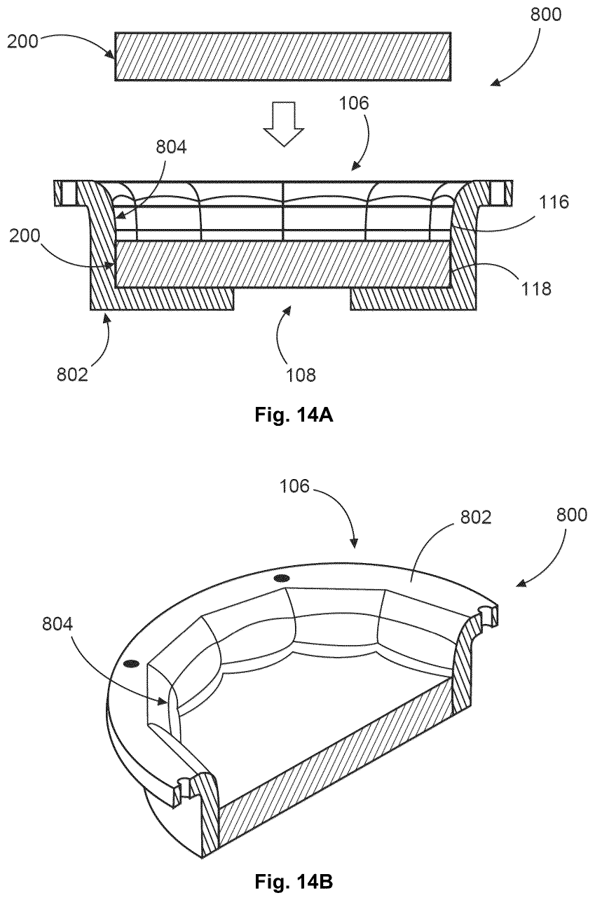

FIGS. 14A, B show a filter holder in a third alternative embodiment.

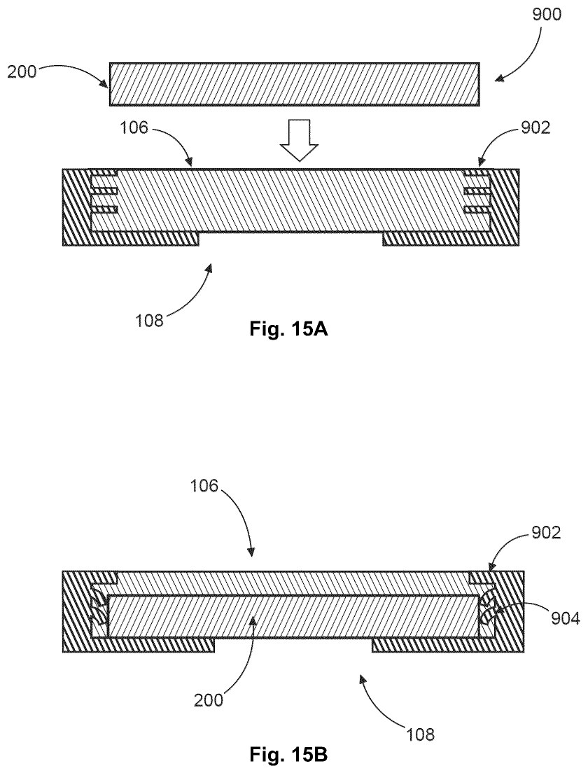

FIGS. 15A, B show a filter holder in a fourth alternative embodiment.

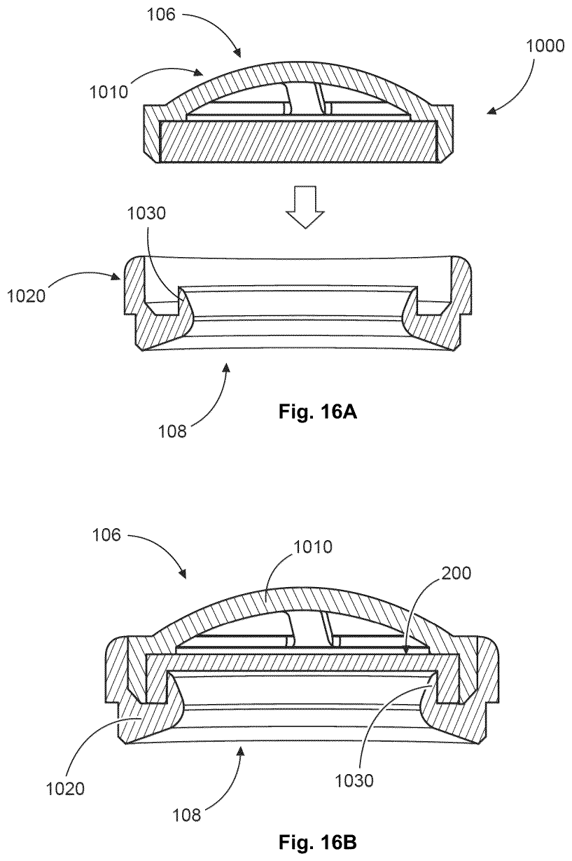

FIGS. 16A, B show a filter holder in a fifth alternative embodiment.

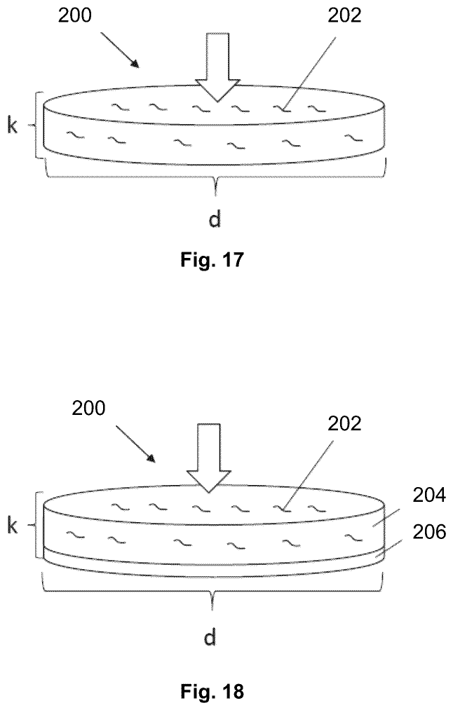

FIG. 17 shows a schematic perspective view of an activated carbon filter for drinking water purification.

FIG. 18 shows a schematic perspective view of an activated carbon filter for drinking water purification in a further or alternative embodiment.

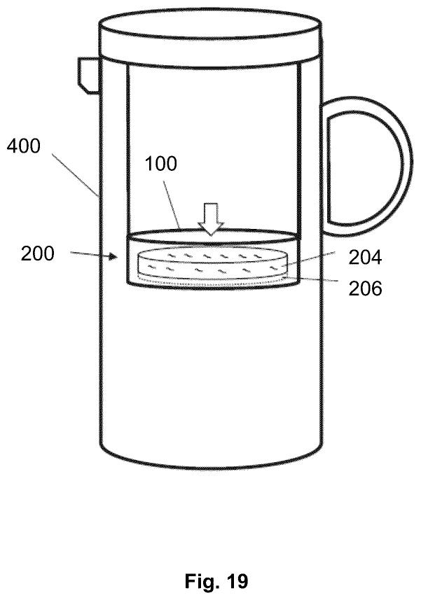

FIG. 19 shows a schematic perspective view of a table water filter with a filter holder and an activated carbon filter.

FIG. 1 shows a schematic top view of an inlet container 402. The inlet container 402 shown here comprises an outlet limiter, which can be arranged in the outlet area of the outlet container when the inlet container 402 is inserted in an outlet container. The inlet container 402 comprises a flow limiter 138. The flow limiter comprises a plurality of flow-through holes 139 arranged on two concentrically arranged circles.

FIG. 2 shows a schematic sectional view of a device for holding a filter pad with a frame 102, a holding element 104 and an inlet container 402, wherein in this view the inlet container 402 and the frame 102 are not connected to one another. The inlet container 402 has a flow limiter 138 with several flow-through holes 139. Below the flow limiter 138, webs 191 are arranged, which are arranged in a substantially radial direction. The radial direction is to be understood as a direction orthogonal to the flow direction 110. The inlet container 402 further comprises a radially circumferential second pressing element 122 and a radially circumferential sealing projection 150 extending parallel thereto, wherein a radially circumferential channel 151 is formed between the second pressing element 122 and the sealing projection 150.

In the view not composed in FIG. 2, a frame 102 with a substantially cylindrical outer surface is arranged at a distance from the inlet container 402. A holding element 104 is arranged within the frame 102. The holding element forms a disk-shaped receiving region 105 with a height H and a diameter D, in which a disk-shaped filter pad 200 is inserted, the thickness of the filter pad corresponding substantially to the height H of the receiving region 105 and the diameter of the filter pad corresponding substantially to the diameter D of the receiving region 105.

The holding element 104 has a first pressing element 121 in the radially outer area of the receiving region 105. As shown here, the first pressing element 121 can be designed as a radially circumferential shoulder for supporting the filter pad 200. The inlet opening 106 is arranged in the upper region of the holding element 104 and the outlet opening 108 is arranged in the lower region of the holding element 104. The outlet opening 108 is designed as a centrally arranged through hole. Radially aligned webs 181 are arranged in the lower region of the receiving region 105, between which channels 182 are formed.

The frame 102 has a radially circumferential connecting portion 103 inside the frame 102, on which a plurality of bayonet elements 136 are arranged. The frame 102 can be moved in the assembly direction Z, so that the frame 102 is connected to the inlet container 402. For this purpose, the bayonet elements 136 of the frame are guided into the bayonet mounts 137 of the inlet container provided for this purpose. A detachable connection between the frame 102 and the inlet container 402 is produced by interaction of the bayonet elements 136 and the bayonet mounts 137.

FIG. 3 shows a schematic sectional view of a device for holding a filter pad 200 with a frame 102, a holding element 104 and an inlet container 402, wherein in this view the inlet container 402 and the frame 102 are connected to one another in contrast to the representation shown in FIG. 2. A detachable connection between the frame 102 and the inlet container 402 is thus produced here by interaction of the bayonet elements 136 and the bayonet mounts 137.

When the frame 102 and the inlet container 402 are assembled as shown here, a pressing section 120 is formed. The pressing section 120 is formed between the first pressing element 121 and the second pressing element 122. The filter pad 200 is compressed radially around the circumference between the first pressing element 121 and the second pressing element 122 and thus held in position.

A radially circumferential sealing section 160 is provided between the sealing projection 150 and the holding element 104. Along this sealing section 160, a radially circumferential fluid-tight connection is provided between the holding element 104 and the sealing projection 150. This can prevent water from escaping laterally.

FIG. 4 shows a highly simplified schematic representation of a table water filter 400. The table water filter 400 has an inlet container 402 with a frame 102 attached to the inlet container 402, wherein a filter pad 200 is arranged within the frame 102. This provides a filter system 300. The inlet container 402 is inserted into an outlet container 404.

FIG. 5a shows a first embodiment of a filter pad 200 for insertion into a device for holding a filter pad 200. The filter pad 200 is disk-shaped and has a filter thickness k and a filter diameter d. The filter pad 200 is designed as an activated carbon filter for drinking water purification, wherein the filter pad 200 is made of activated carbon fiber 202. The filter diameter d is in a range from 65 millimeters to 75 millimeters. The filter thickness k is in the range from 6 millimeters to 12 millimeters.

The activated carbon filter 200 has an ion exchanger, not shown, which is formed with polyacrylate. The activated carbon filter 200 has a binder formed with polyester. The activated carbon filter 200 has an intrinsic weight that is less than 10 grams. In addition, the activated carbon filter 200 has a filtration rate of less than 1 liter per two minutes. The activated carbon filter 200 is made exclusively of activated carbon fiber 202, the ion exchanger and the binder.

Optionally, the activated carbon filter 200 is set up to mineralize or add the additives to liquid filtered by additives introduced into the activated carbon filter, such as water, wherein minerals, flavorings, electrolytes or the like can be provided as additives.

The arrow shown in FIG. 5a describes the flow direction of the liquid through the activated carbon filter 200.

FIG. 5b shows a second embodiment of a filter pad 200 for insertion into a device for holding a filter pad 200. The filter pad 200 is disk-shaped and has a filter thickness k and a filter diameter d.

The activated carbon filter 200 is formed with two layers 204, 206. The first layer 204 is formed of activated carbon fibers 202, a binder and an ion exchanger, as described, for example, above with respect to FIG. 5a. The second layer 206 is formed with additives introduced to mineralize or add the additives to the liquid filtered by the first layer 204 by means of the second layer 206. The additives may be minerals, flavorings, electrolytes or the like as described above with respect to FIG. 5a. The second layer 206 optionally has a different color than the first layer 204.

The arrow shown in FIG. 5b describes the flow direction of the liquid through the activated carbon filter 200.

FIG. 6 shows a schematic representation of a method 600 for purifying water. The method 600 comprises the following steps: In a step 610, providing a device as described herein. In a step 620, inserting a filter pad 200 into the receiving region 105. In a step 630, connecting the frame 102 to the inlet container 402. In a step 640, inserting the inlet container 402 into an outlet container 404. In a step 650, filling water to be purified into the inlet container 402.

FIG. 7 shows a filter holder 100 for holding a filter pad 200 for water purification. The filter holder 100 comprises a frame 102, which is formed from a holding ring 132 and a frame part 134. The frame is structurally rigid, namely made of a plastic.

The filter holder further comprises an elastic holding element 104 received in the frame 102 for receiving the filter pad 200, wherein the holding element 104 and the frame 102 have an inlet opening 106 and an outlet opening 108. A flow direction 110 is formed from the inlet opening 106 to the outlet opening 108, which is illustrated as an arrow. The inlet opening 106 and the outlet opening 108 are arranged opposite each other in the flow direction 110.

The elastic holding element 104 has a fixed end 112 and a free end 114. The holding element is mechanically connected to the frame 102 at the fixed end 112, namely by means of a clamping connection.

The elastic holding element 104 is made of silicone and is therefore elastically deformable. The flexibility of the silicone allows it to adapt to filter pads of different sizes. Silicone also seals well due to its elastic properties.

The elastic holding element 104 has a receiving portion 116, which extends from the fixed end 112 in the direction of the free end 114. The receiving portion tapers in the opposite direction to the flow direction 110, namely with a curved shape. The receiving portion 116 serves as an insertion aid or placement aid for a filter pad 200.

The elastic holding element 104 also has a sealing section 118, the sealing section 118 being the portion at which the elastic holding element 104 and a received filter pad 200 are in direct contact, as shown, for example, in FIG. 8. The sealing section 118 shown extends parallel to the flow direction 110 and the sealing section 118 directly adjoins the receiving portion 116.

The free end 114 of the holding element 104 also has a limiting projection 120a in order to limit insertion of a filter pad or the filter pad 200 into the holding element. Such a limitation is shown, for example, in FIG. 8.

The free end 114 further comprises a sealing groove 122a, wherein the sealing groove 122a is preferably oriented opposite the flow direction 110 at the free end 114. A sealing lip 148 may be placed in the sealing groove 122a, as shown, for example, in FIG. 9B.

A deflection area 124 is formed between the frame 102 and the elastic holding element 104. The deflection area in FIG. 7 is formed as a cavity into which the elastic holding element can move. If a filter pad 200 with a larger diameter is inserted into the elastic holding element 104, the cavity is reduced slightly accordingly. In this way, manufacturing tolerances of the filter pad 200 can be compensated for.

The frame 102 further comprises a compression portion 126 having a compression surface 128, wherein the compression surface 128 faces the holding element 104 and the elastic holding element 104 is adapted to be disposed along the compression surface 128 by deformation. This is illustrated, for example, in FIG. 3B. The compression portion 126 tapers linearly in the flow direction 110 and is oriented at an acute angle of 45° with respect to the longitudinal axis 130.

The frame 102 is also formed in multiple parts and includes a holding ring 132 that includes the compression portion 126. The holding ring 132 forms a clamping connection with a frame part 134 for the fixed end 112 of the elastic holding element 104.

The fixed end 112 has two opposing fastening projections 140 for mechanically fastening the elastic holding element 104 to the frame 102.

The frame 102 is also formed with a bayonet mount 136a for receiving a bayonet counterpart, wherein the bayonet mount 136a is arranged on the inside of the frame 102. FIG. 7 shows two bayonet mounts 136a that are arranged opposite one another.

The frame 102 and the elastic holding element 104 are annular in shape, as shown, for example, in FIG. 11.

Not shown in FIG. 7 is a flow limiter 138 (but shown in FIG. 3A) for limiting a quantity of water, which is arranged in the region of the inlet opening 106, as shown, for example, in FIG. 9B.

FIG. 8 shows a sectional view of a holding element 100 according to the invention, as shown, for example, in FIG. 7. In contrast to the embodiment in FIG. 7, a filter pad 200 is inserted into the elastic holding element 104. In the joined state shown, the elastic holding element 104 thus forms a press connection with the filter pad 200 received. At the point where the filter pad 200 and the elastic holding element 100 touch, an equally distributed pressing force acts at least partially on the filter pad 200 at the sides 142 of the filter pad.

The filter holder 100 and the filter pad 200 thus form a filter system 300, as shown in FIG. 7 or 8, for example.

FIG. 9A shows a sectional view of a filter holder 100. In contrast to FIG. 7 or 8, the filter holder 100 is rotated by 180 degrees. This allows the filter or filter pad 200 to be inserted into the elastic holding element 104 from above. The insertion direction 144 is illustrated by the arrow, which is opposite to the flow direction 110, which is not illustrated in FIG. 3A. FIG. 9A also illustrates a variable diameter 146 of the holding element 104. The diameter 146 is variable due to the elastic properties of the holding element 104. This is illustrated by the double arrow in FIG. 9A. Due to the one-sided fixation to the frame 102 and the flexible properties of the holding element 104, the diameter 146 adapts to the structural dimensions of the filter pad 200.

FIG. 9B shows a sectional view of a filter holder 100, as shown for example in FIGS. 1 to 3A. In contrast to FIGS. 7 to 9A, FIG. 9B shows a deformation of the elastic holding element along the compression portion of the 126.

FIG. 9B shows how the flexible filter holder 100 is screwed to a filling container or inlet container by means of a bayonet lock. The bayonet lock consists of the bayonet mount 136a and the bayonet counterparts 150a. The double sealing lip or groove 122a forms a watertight transition with the counterpart on the inlet container 402, which is designed as a sealing lip 148, and is secured against slipping by the sealing guide 122a, since the groove 122a forms a guide. The elastic holding element, which can also be understood as a silicone filter holder, deforms along the dotted lines shown. The direction of deformation is shown with arrows. The deformation of the elastic holding element 104 and its contact with the compression surface 128 compresses the filter pad 200 and prevents it from slipping out. As can be seen from the dotted line, the receiving portion 116 forms a kind of bead or protrusion in the region of the outlet opening 108 after the elastic holding element 104 has been fitted and compressed, when the elastic filter element is fitted and the inlet container 402 is screwed to the filter holder 100. This bead-like embodiment 152 serves to protect the filter against breaking through or being pushed out in the flow direction 110 of the filtered water. As can be seen in FIG. 9B, the filter holder 100 is formed with the compression slope 128 such that the receiving portion 116 in the region of the outlet opening 108 is deformed in such a way that the receiving portion 116 at least partially embraces the dashed filter pad 200 in order to secure the filter pad against slipping out in the flow direction 110.

FIG. 10 shows a table water filter with a filter holder 100 in one embodiment. The table water filter is formed with an inlet container 402 and an outlet container 404. The inlet container 402 is arranged inside the outlet container 404. Water to be purified is filled into the inlet container 402. The filter holder 100 with a filter pad 200 is arranged at a lower end of the inlet container 402. The water that is filled into the inlet container 402 thus seeps through the filter 200 held in place and is purified. The filter holder 100 and the filter pad 200 thus form a filter system 300.

FIG. 11 shows a perspective view of a filter holder 100 in a further embodiment, as shown, for example, in FIGS. 1 to 3B. The frame 102 and the elastic holding element 104 are annular in shape. The elastic holding element 104 is mechanically attached to the frame 102, as previously described. The holding element 104 has a receiving portion 116, a sealing section 118, a limiting projection 120a, and a compression surface 128, as previously described.

FIGS. 12A and 12B show a filter holder in a first alternative embodiment, namely a clamping holder 600a. The clamping holder 600a has a plurality of hard jaws 602, which are non-elastic. In addition, the clamping holder 600a has a plurality of soft jaws 604, which are designed to be elastically deformable. The clamping holder 600a is annular in shape. The clamping holder 600a thus forms a type of collet. The collet or the clamping holder 600a is widened by moving the hard jaws in the direction indicated by the arrows, i.e. by pulling them apart. The hard jaws 602 are connected to the soft jaws 604, preferably by means of two-component injection molding or the like. By moving the hard jaws 602, it is possible to insert the filter 200. After the filter 200 has been inserted, the clamping holder is relaxed and contracts around the filter 200. In addition, the clamping holder has a fastening projection that is not shown, in particular as described above. FIG. 6A shows a perspective view of the clamping holder 600a and FIG. 6B shows a top view of the clamping holder 600a with a joined filter pad 200.

FIGS. 13A and 13B show a filter holder in a second alternative embodiment, namely a squeeze holder 700. The squeeze holder 700 is formed from a fixed frame 702. The frame 702 forms a press fit into which a filter pad 200 can be pressed. The pinch switch has a conical opening 704, which forms a receiving portion 116. In addition, the squeeze holder 700 has a sealing section 118 which runs parallel to a flow direction, the flow direction extending from the inlet opening 106 to the outlet opening 108. The basic principle is that the filter or filter pad 200 is inserted and pressed into the holder 700 through the conical opening 704. Due to the conical geometry of the inner surface, the filter 200 is pressed together and held at the bottom in the end position. The result is an interference fit. The diameter of the sealing section 118 is smaller than the diameter of the filter pad 200 in order to form an interference fit. FIG. 13A shows a sectional side view of the squeeze holder 700 and FIG. 13B shows a perspective sectional view of the squeeze holder 600a.

FIGS. 14A and 14B show a filter holder in a third alternative embodiment, namely a polygon holder 800. The polygon holder 800 is formed from a fixed frame 802. The frame 802 forms a press fit into which a filter pad 200 can be pressed. The polygon holder has a polygon-shaped opening 804, which forms a receiving portion 116. In addition, the polygon holder 800 has a sealing section 118 which runs parallel to a flow direction, the flow direction extending from the inlet opening 106 to the outlet opening 108. The basic principle is that the filter or filter pad 200 is inserted and pressed into the holder 800 through the polygon-shaped opening 804. The polygon-shaped geometry of the inner surface presses the filter 200 together and holds it in the end position at the bottom. The result is an interference fit. The diameter of the sealing section 118 is smaller than the diameter of the filter pad 200 in order to form an interference fit. It is advantageous that the filter 200 has the same geometry as the curved inner contour when it is pressed in. This prevents unwanted folds on the filter edge during pressing in. FIG. 14A shows a sectional side view of the polygon holder 800 and FIG. 14B shows a perspective sectional view of the polygon holder.

FIGS. 15A and 15B show a filter holder in a fourth alternative embodiment, namely a lamella holder 900. Deformable lamellae 902 are used here to compensate for filter tolerances of the filter pad 200. The lamellae are made of silicone, for example. The lamellae are bent over when the filter 200 is pressed in, as shown in FIG. 15B for example, and hold the filter 200 firmly in the holder 900. FIG. 15B shows a simplified representation with three lamellae 902 and 904. Different filter thicknesses can be used by increasing the number of lamellae as desired.

FIGS. 16A and 16B show a filter holder in a fifth alternative embodiment, namely a cutting clamp holder 1000. The basic principle of the cutting clamp holder is that the filter or the filter pad 200 is pre-positioned in a clamping cover 1010 and then pressed on with the clamping cover. During pressing, a pointed edge 1030 of the holder 1020 cuts into the inserted filter 200 and ensures that it is firmly positioned in the holder 1020, as shown in FIG. 10B, for example. Tolerances on the diameter of the filter 200 are therefore not relevant, as a defined part of the filter is always clamped off and used.

FIG. 17 shows an activated carbon filter 200 for drinking water purification, wherein the activated carbon filter 200 is made of activated carbon fiber 202 and has a filter diameter d and a filter thickness k. The filter diameter d is in a range from 65 millimeters to 75 millimeters. The filter thickness k is in a range from 6 millimeters to 12 millimeters.

The activated carbon filter 200 has an ion exchanger, not shown, which is formed with polyacrylate. The activated carbon filter 200 has a binder which is formed with polyester. The activated carbon filter 200 is disk-shaped and has an intrinsic weight of less than 10 grams. In addition, the activated carbon filter 200 has a filtration rate of less than 1 liter per two minutes and is made exclusively of activated carbon fiber, the ion exchanger and the binder.

Optionally, the activated carbon filter 200 is set up to mineralize or add the additives to liquid filtered by additives introduced into the activated carbon filter, such as water, wherein minerals, flavorings, electrolytes or the like can be provided as additives.

The arrow shown in FIG. 17 describes the flow direction of the liquid through the activated carbon filter 200.

FIG. 18 schematically shows a perspective view of an activated carbon filter 200 for drinking water purification in a further embodiment.

The activated carbon filter 200 is designed with two layers 204, 206.

The first layer 204 is formed from activated carbon fibers, a binder and an ion exchanger, as described, for example, above with respect to FIG. 17.

The second layer 206 is formed with additives introduced to mineralize or add the additives to the liquid filtered by the first layer 204 by means of the second layer 206. The additives may be minerals, flavorings, electrolytes or the like as described above with respect to FIG. 17.

The second layer 206 optionally has a different color than the first layer 204.

The arrow shown in FIG. 18 describes the flow direction of the liquid through the activated carbon filter 200.

FIG. 19 shows a filter holder 100 with an activated carbon filter 200, for example with the activated carbon filter 200 as shown in FIG. 17 or 18 and as described above. As can be seen in FIG. 19, the second layer 206 is shown dotted to illustrate it as an alternative or extended embodiment.

The filter holder 100 shown is, for example, part of a table water filter 400. FIG. 19 thus also illustrates a table water filter 400 with an activated carbon filter 200. FIG. 19 thus also illustrates a use of the activated carbon filter 200 for drinking water purification, namely in a table water filter.

### LIST OF REFERENCE SYMBOLS

| | | | |
|---|---|---|---|
| 100 | Filter holder, | | |
| 102 | Frame | | |
| 103 | Connecting portion | | |
| 104 | Holding element, | | |
| 106 | Inlet opening | | |
| 105 | Receiving region | 108 | Outlet opening |
| 110 | Flow direction | | |
| 112 | fixed end | | |
| 114 | free end | | |
| 116 | Receiving portion | | |
| 118 | Sealing section | | |
| 120 | Pressing section, | | |
| 120a | Limiting projection | | |
| 121 | first pressing element | | |
| 122 | second pressing element, | | |
| 122a | Sealing groove | | |
| 124 | Deflection area | | |
| 126 | Compression portion | | |
| 128 | Compression surface | | |
| 130 | Longitudinal axis | | |
| 132 | Holding ring | | |
| 134 | Frame part | | |
| 136 | Bayonet element, | | |
| 136a | Bayonet mount | | |
| 137 | Bayonet mount | | |
| 138 | Flow limiter | | |
| 139 | Flow-through holes | | |
| 140 | Fastening projection | | |
| 142 | Sides of a filter pad | | |
| 144 | Inserting direction | | |
| 146 | Diameter of the holding element | | |
| 148 | Sealing lip | | |
| 150 | Sealing projection, | | |
| 150a | Bayonet counterpart | | |
| 151 | Radially circumferential channel | | |
| 152 | Bead-like shape | | |
| 160 | Sealing section | | |
| 181 | Webs of the holding element | | |
| 182 | Channels of the holding element | | |
| 191 | Webs of the flow limiter | | |
| 200 | Filter pad, activated carbon filter | | |
| 202 | Activated carbon fibers | | |
| 204 | first layer of the filter pad | | |
| 206 | second layer of the filter pad | | |
| 300 | Filter system, | | |
| 400 | Table water filter | | |
| 402 | Inlet container | | |
| 403 | Outlet limiter | | |
| 404 | Outlet container | | |
| 600 | Process for purifying water, | | |
| 600a | Clamping holder | | |
| 610 to 650 | Method steps | | |
| 602 | hard jaws | | |
| 604 | soft jaws | | |
| 700 | Squeeze holder | | |
| 702 | fixed frame | | |
| 704 | cone-shaped opening | | |
| 800 | Polygon holder | | |
| 802 | fixed frame | | |
| 804 | polygon-shaped opening | | |
| 900 | Lamella holder | | |
| 902 | Lamellae | | |
| 904 | Curved lamella | | |
| 1000 | Cutting clamp holder | | |
| 1010 | Clamping cover | | |
| 1020 | Clamping holder | | |
| 1030 | pointed edge | | |
| D | Diameter of the receiving region | | |
| H | Height of the receiving region | | |
| d | Filter diameter | | |
| k | Filter thickness | | |
| Z | Assembly direction | | |

1. Device for holding a filter pad for water purification, the device comprising
a frame having a connecting portion for making a detachable connection with an inlet container,
a holding element arranged within the frame,
wherein the holding element has an inlet opening and an outlet opening and a flow direction is formed from the inlet opening to the outlet direction,
wherein the holding element forms a receiving region for receiving a filter pad, wherein the receiving region has a height (H) in the flow direction and a diameter (D) in a radial direction which is orthogonal to the flow direction,
a pressing region for fixing the filter pad, wherein the pressing region is arranged in the outer region of the receiving region in the radial direction, wherein the pressing region is formed by a first pressing element of the holding element and a second pressing element, wherein the first pressing element and the second pressing element are formed and arranged to compress a filter pad received in the receiving region in the radially outer region of the receiving region.

2. Device according to claim 1, comprising
an inlet container for receiving water to be purified, wherein the inlet container is detachably connected to the connecting portion of the frame,
wherein preferably the second pressing element is formed integrally with the inlet container.

3. Device according to claim 1,
wherein the connecting portion of the frame has at least one bayonet element, and
wherein the inlet container has at least one bayonet mount for receiving the at least one bayonet element.

4. Device according to claim 1,
wherein the outlet opening is arranged centrally in the holding element in the radial direction and is smaller than the inlet opening.

5. Device according to claim 1,
wherein the holding element has radially arranged webs, wherein channels are formed between the webs of the holding element, which are radially aligned and extend in the direction of the outlet opening.

6. Device according to claim 1,
wherein a flow limiter for limiting a quantity of water is arranged in the region of the inlet opening of the holding element, the flow limiter having a plurality of flow-through holes.

7. Device according to claim 6,
wherein webs are arranged between the flow-through holes of the flow limiter on the side of the flow-through holes facing the receiving region, which webs form channels which are aligned in the direction of the outlet opening.

8. (canceled)

9. Device according to claim 1,
wherein the frame and the holding element are connected to one another.

10. Device according to claim 1,
wherein the inlet container has a sealing projection, which is formed integrally with the inlet container, wherein the sealing projection bears radially circumferentially against the holding element in order to form a fluid-tight connection between the inlet container and the holding element.

11. Device according to claim 10,
wherein the sealing projection and the second pressing element extend parallel to one another, are arranged radially circumferentially and form a radially circumferential channel located therebetween.

12. Device according to claim 10,
wherein the inlet opening and the outlet opening are arranged on opposite sides of the receiving region in the flow direction.

13-19. (canceled)

20. Device according to claim 1, comprising an activated carbon filter for drinking water purification, wherein the activated carbon filter is formed from activated carbon fiber and has a filter diameter (d) and a filter thickness (k), characterized in that
the filter diameter (d) is in a range from 65 millimeters to 75 millimeters, and the filter thickness (k) is in a range from 6 millimeters to 12 millimeters.

21-22. (canceled)

23. Device according to claim 20, wherein the activated carbon filter comprises an ion exchanger formed with polyacrylate.

24. Device according to claim 20, wherein the activated carbon filter comprises a binder formed with polyester.

25. Device according to claim 20, wherein the activated carbon filter is disk-shaped.

26. Device according to claim 20, wherein the activated carbon filter has an intrinsic weight that is less than 10 grams.

27. (canceled)

28. Device according to claim 20, wherein the activated carbon filter is formed exclusively of activated carbon fiber, an ion exchanger and a binder.

29. (canceled)

30. Device according to claim 20, wherein the activated carbon filter comprises two layers, wherein a first layer is formed of activated carbon fibers, a binder and an ion exchanger, and a second layer is formed with additives introduced to mineralize or add the additives to a liquid filtered with the first layer by means of the second layer.

31. Device according to claim 30, wherein
the additives are minerals,
the additives are flavorings; and/or
the additives are electrolytes.

32-35. (canceled)

36. A method for purifying water, comprising the steps of:
Providing a device according to claim 1,
Inserting a filter pad, which is formed an activated carbon filter, into the receiving region,
Connecting the frame to the inlet container,
Inserting the inlet container into an outlet container,
Filling of water to be cleaned into the inlet container.

37. (canceled)
